(19) United States
(12) Patent Application Publication
(10) Pub. No.: US 2017/0040929 A1
(43) Pub. Date: Feb. 9, 2017

(54) Integrated Solar Energy Roof System

(71) Applicant: Advanced Building Systems, Inc., Wilmington, DE (US)

(72) Inventor: Raymond M.L. Ting, Pittsburgh, PA (US)

(21) Appl. No.: 15/223,534

(22) Filed: Jul. 29, 2016

Related U.S. Application Data
(60) Provisional application No. 62/208,253, filed on Aug. 21, 2015.
(60) Provisional application No. 62/201,920, filed on Aug. 6, 2015.

(51) Int. Cl. H02S 20/23; H02S 20/26

(52) U.S. Cl. CPC H02S 20/23; H02S 20/26; F24J 2002/0061

(57) ABSTRACT

Roof panels with an integrated solar energy unit secured in a perimeter frame are disclosed. Pressure equalized airloops are provided around the perimeter frame to prevent water leakage. The solar energy units in adjacent roof panels are electrically connected by wires penetrating the head frame member of each roof panel and passing through a supporting mullion between the adjacent panels.

### CROSS-REFERENCE TO RELATED APPLICATIONS

This application claims the benefit under 35 U.S.C. §119(e) of the earlier filing dates of U.S. Provisional Patent Application No. 62/201,920 filed on Aug. 6, 2015, and U.S. Provisional Patent Application No. 62/208,253 filed on Aug. 21, 2015.

### BACKGROUND OF THE INVENTION

1. Field of Invention

This invention relates to an exterior panelized roof system with integrated solar energy units.

2. Background of the Invention

The major function of an exterior roof system is to provide interior environmental protections including water drainage and water tightness, structural safety against wind load & seismic load, thermal insulation, and optional control of sun light entry into the building. Four common commercially available exterior roof systems listed below.

1. A panelized glass roof with a pitched roof surface known as a skylight with hidden frame glass panels and perfectly sealed panel joints to allow water to flow over the panel joints.

2. A panelized metal skin roof with a pitched roof surface known as an upstanding seam metal panel roof in which the upstanding and sloping panel joints are sealed and structurally seamed and connected to the roof supporting purlins with or without a transverse lapped panel joint.

3. A non-panelized roof system known as a shingled roof with a pitched roof surface commonly used on residential houses.

4. A non-panelized roof system known as a membrane roof with a practically flat roof surface commonly used on commercial buildings.

Based on current solar energy technology, all commercial solar energy units use a glass pane as the facing material. Therefore, for the roof systems listed as items 2, 3, and 4 above, a solar energy generating system can only be installed above the roof as a separate structure with significant additional cost. A panelized glass roof is the only type of roof system that can be considered for integrating solar energy units into the roof system. However, the following two factors must be considered.

Maintenance: The commercially available sealant material to make perfectly sealed panel joints is silicone caulking. However, a perfect seal with severe sun exposure will eventually degrade due to UV-light exposure. Therefore, frequent maintenance of panel joints by re-caulking becomes necessary. In addition, it is known in the industry that seagulls like to pick on silicone caulking in panel joints, creating additional maintenance problems in seashore or lakeshore areas. For these reasons, a panelized glass roof system is typically used only for the limited areas of skylights in commercial buildings. To generate adequate solar energy, the area of the panelized solar energy roof must be significant and the resulting maintenance cost becomes economically not viable.

Replacement of a Solar Energy Unit: To replace a dysfunctional or damaged solar energy unit, high technical difficulty with serious interruption of building interior functions and cost are involved.

There are many integrated solar energy roof examples on open structures such as balcony roof or other commercial shade roof. The impact of water leakage is significantly reduced for such open structures, because consideration of building interior functions is not required. However, due to the above two considerations, there has been no integrated solar energy roof system on an enclosed building.

From the above review of the state of the art, it becomes apparent that an economical solution for an integrated solar energy roof on an enclosed building is desirable. For example, a popular roof-top restaurant can be formed by increasing the support height of a roof-top solar energy system on a commercial building and enclosing the structure with walls around it.

Some objectives of preferred embodiments of the present invention are to provide a solar energy roof system fulfilling the functional performances listed below.

1. Integrating any commercially available solar energy unit into a panelized glass roof on an enclosed structure while maintaining all performance functions of the roof.

2. Easy replacement of an individual solar energy unit from the inside of the building.

3. Significant economic value over a separate solar energy structure on top of a roof.

### BRIEF SUMMARY OF THE INVENTION

Preferred embodiments of the present invention include solar energy units integrated into a roof panel. Preferred roof panels are airloop panels utilizing the pressure equalization airloop principle as described in U.S. Pat. Nos. 5,598,671 and 7,134,247, which are incorporated by reference. A pressure-equalized airloop system utilizes two seals that separate the functions of sealing water and air, providing acceptable air and water infiltration rates even with imperfect seals. In addition, one embodiment of an airloop system allows panels to be shop-assembled with perimeter panel frame extrusions so that a more reliable seal can be fabricated and a pressure equalized inner airloop is formed along the facing panel frame edges. A pressure equalized outer airloop is formed with bordering panel frames after field erection of the panels.

In preferred embodiments of the present invention, the airloop principle used for wall panels is adapted for use in roof panels. Pressure equalization is facilitated by mullion cavities that are open at the lower, eave end of the roof.

A solar energy unit is used as the facing panel for the roof panel, such that the solar energy unit is integrated into the roof structure. Due to the pressure equalization of all joint cavities, an airloop system can tolerate a high degree of imperfection in both water seal and air seal lines without causing water leakage. Thus, electrical wiring penetrations in the roof panel frame required for integration of solar energy panels may be made between pressure-equalized spaces without increasing the risk of water leakage.

In preferred embodiments, a solar energy unit is held in an airloop panel frame to form a roof panel. The perimeter frame members form pressure-equalized airloops around the perimeter of the solar energy unit. When the curtain wall is erected, solar energy units in adjacent roof panels may be electrically connected in series via a wire passing through a hole in the head frame member of each roof panel and through the mullion between the roof panels.

In preferred embodiments, mullions supporting the roof panels are connected to the building structure using a mullion clip that slidably engages with the mullion using matching male and female joints. This type of mullion connection system is disclosed in U.S. Patent Application Publication No. 2013/0186031, which is incorporated by reference. This type of mullion connection systems does not require a fastener penetrating the mullion, which provides an uninterrupted mullion cavity that can be used for electrical wiring.

### BRIEF DESCRIPTION OF THE DRAWINGS

FIG. 1 shows an isometric view of a typical fragmented panelized solar energy roof of a preferred embodiment of the present invention.

FIG. 2 shows a fragmental cross-section taken along line 2-2 of FIG. 1, at a transverse panel joint between roof panels having an integrated, single glass solar energy unit.

FIG. 3 shows a fragmental cross-section at a transverse panel joint between roof panels having an integrated, single glass solar energy unit with a structural back-up panel.

FIG. 4 shows a fragmental cross-section at a transverse panel joint between roof panels having an integrated, double glass solar energy unit.

FIG. 5 is a fragmental cross-section taken along line 5-5 of FIG. 1, looking downwardly at the head frame members of adjacent eave panels, showing the engagement between each eave panel and a supporting mullion, and showing a preferred wiring path for making an electrical connection between solar energy units in adjacent eave panels.

FIG. 6 is a fragmental isometric view from the interior side looking upwardly towards the bottom of the head frame members of adjacent panels on each side of a supporting mullion.

FIG. 7 is a fragmental cross-section taken along line 7-7 of FIG. 1, showing a typical ridge condition.

FIG. 8 is a fragmental cross-section taken along line 8-8 of FIG. 1, showing a typical eave condition.

FIG. 9 is a cross-sectional view of a mullion with a mullion connection clip.

### DETAILED DESCRIPTION OF THE INVENTION

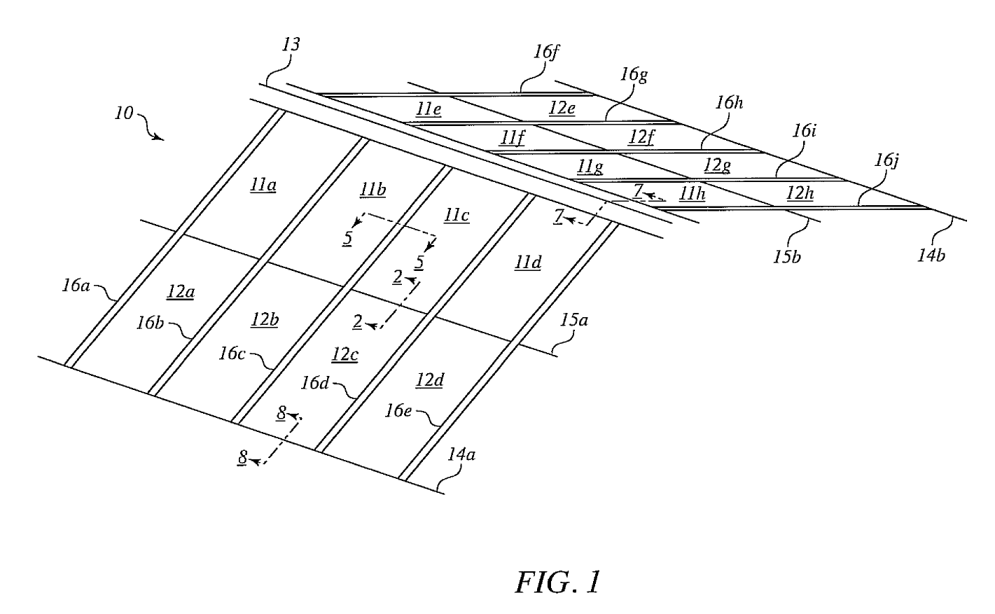

FIG. 1 shows an isometric view of a typical fragmented panelized solar energy roof 10 of a preferred embodiment of the present invention. The roof 10 is formed by multiple roof panels 11a-11h along each side of a ridge line 13, and multiple roof panels 12a-12h along eave lines 14a, 14b. Each of the roof panels 11a-11h, 12a-12h has an integrated solar energy unit. Multiple continuous longitudinal joints 16a-16j from the ridge line 13 to the eave lines 14a, 14b are formed between adjacent panels. Multiple intermediate transverse joints along lines 15a, 15b, interrupted at each longitudinal joint 16a-16j, are formed between the ridge line 13 and eave lines 14a, 14b. The transverse joints in the preferred embodiment shown in FIG. 1 are lined up in the transverse direction along lines 15a and 15b, but may be staggered in any fashion.

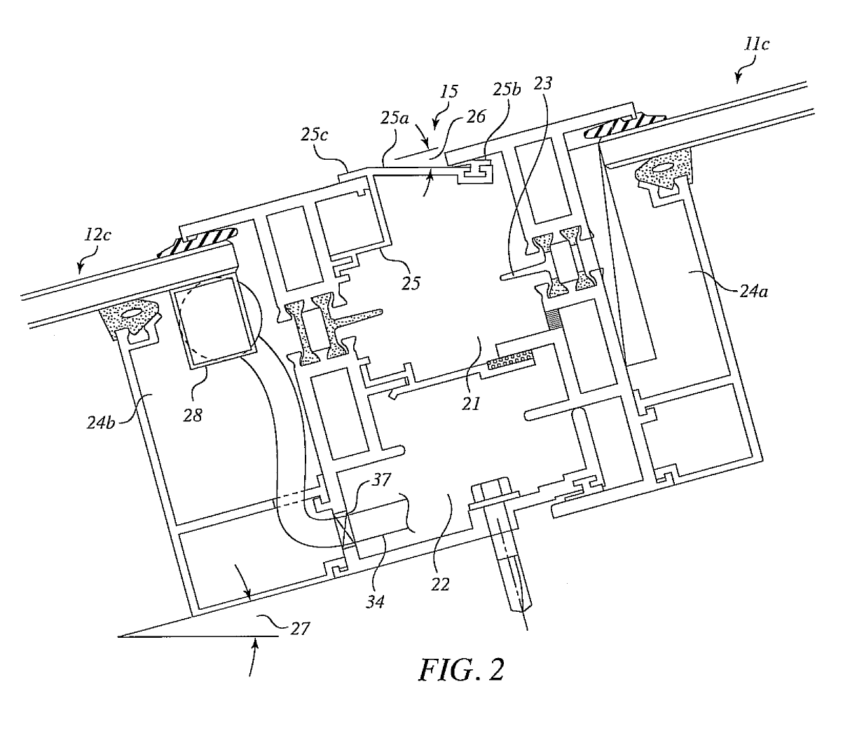

FIG. 2 shows a fragmental cross-section taken along line 2-2 on FIG. 1, at a transverse panel joint 15 between roof panels 11c, 12c. In this preferred embodiment, panels 11c, 12c each have an integrated, uninsulated transparent or semi-transparent single glass solar energy unit. The ridge panel 11c is structurally engaged with the eave panel 12c to form a transverse panel joint 15. Structural engagement of the sill frame member of ridge panel 11c with the head frame member of eave panel 12c forms the outer airloop spaces 21 and 22. The inner airloop space 24a shown in the sill member of ridge panel 11c is connected to corresponding air spaces in the jamb members and head member of ridge panel 11c to form an inner airloop. Air holes 23 at the sill member of ridge panel 11c are provided to pressure equalize the inner airloop space 24a as explained in U.S. Pat. No. 7,134,247.

The inner airloop space 24b shown in the head member of eave panel 12c is connected to corresponding air spaces in the jamb members and sill member of eave panel 12c to form an inner airloop. Air holes at the sill member of eave panel 12c are provided to pressure equalize the inner airloop space 24b of the eave panel 12c with exterior air.

In preferred embodiments, a rain screen member 25 has a joint gap leg 25a with a sloping angle 26 with respect to the face of the roof surface to allow water to flow downwardly over the panel joint 15. The rain screen member 25 also has a water seal gasket 25b and a preferable overlapping leg 25c to minimize water entering the outer airloop space 21. In preferred embodiments, the sloping angle 26 is equal to or less than the horizontal roof slope angle 27 to prevent water from being trapped on the surface of the joint gap leg 25a.

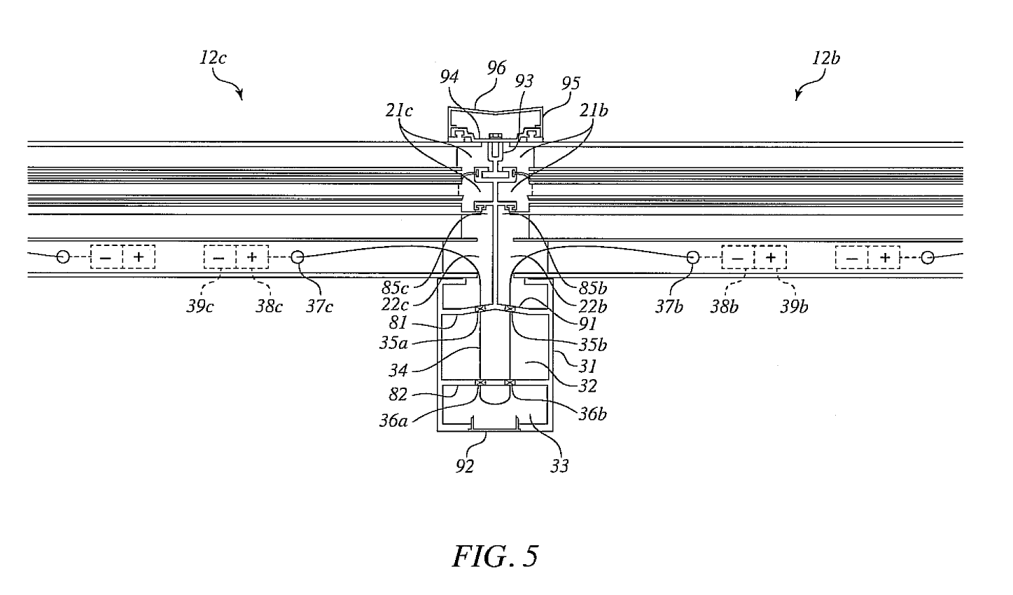

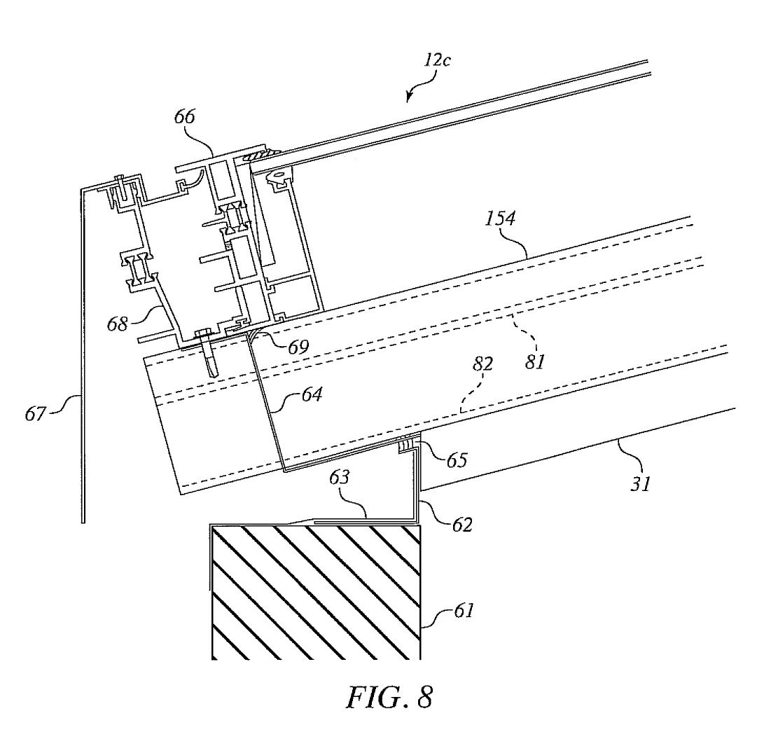

In a typical airloop wall system, the transverse joint between wall panels is open to facilitate pressure equalization in the airloop spaces. In preferred embodiments of the present invention, a rain screen member 25 with water seal gasket 25b are used to permit downward water drainage over the panel joint 15 for a sloping roof. The rain screen member 25 and water seal gasket 25b impede entry of exterior air into the outer airloop space 21 for pressure equalization. Therefore, exterior air entry into the outer airloop spaces 21 and 22 is facilitated by mullion cavities being open at the roof eave, as explained below in the description FIGS. 5 and 8.

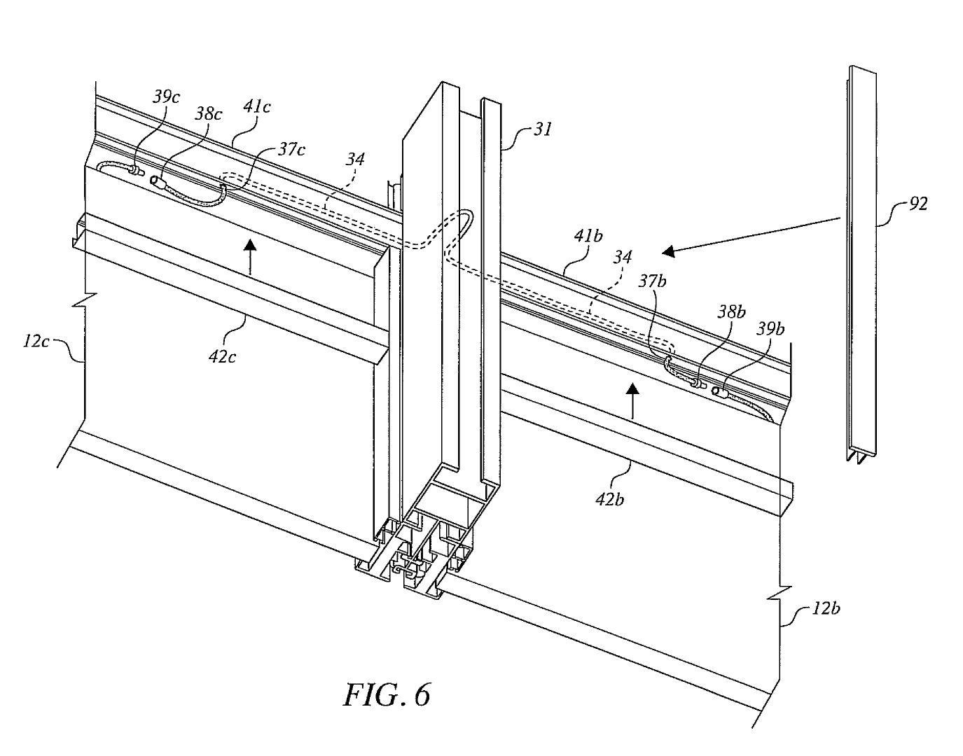

A wiring hole 37 is shop-drilled on the head frame member of panel 12c for connecting the mullion wire 34 to the electrical ports 28 of the solar energy unit in panel 12c, as explained in greater detail in the description of FIGS. 5 and 6.

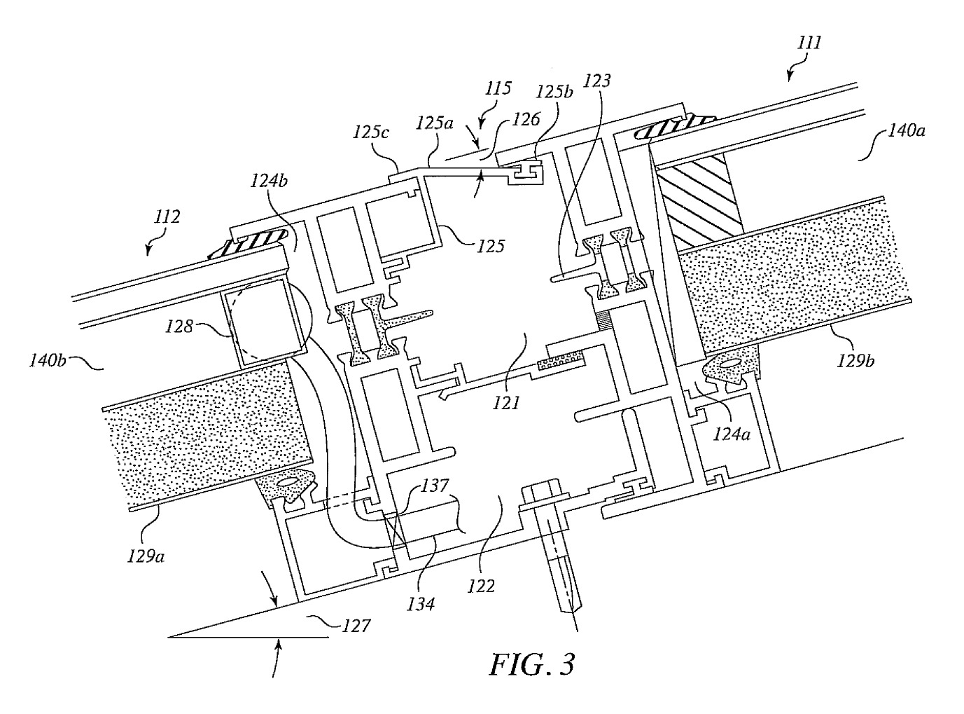

FIG. 3 shows a fragmental cross-section of another embodiment utilizing panels 111, 112 that each have an integrated, single glass solar energy unit with a structural back-up panel 129a, 129b. Similar to FIG. 2, FIG. 3 shows a cross-section at a transverse joint 115 between a ridge panel 111 and an eave panel 112. Structural engagement of ridge panel 111 with eave panel 112 forms the outer airloop spaces 121 and 122. The inner airloop space 124a shown in the sill member of ridge panel 111 is connected to corresponding air spaces in the jamb members and head member to form an inner airloop. Air holes 123 at the sill member of ridge panel 111 are provided to pressure equalize the inner airloop space 124a as explained in U.S. Pat. No. 7,134,247.

The inner airloop space 124b shown in the head member of eave panel 112 is connected to corresponding air spaces in the jamb members and sill members to form an inner airloop. Air holes at the sill member of eave panel 112 are provided to pressure equalize the inner airloop space 124b of the eave panel 112 with exterior air.

Like the embodiment shown in FIG. 2, a rain screen member 125 has a joint gap leg 125a with a sloping angle 126 with respect to the face of the roof surface to allow water to flow downwardly over the panel joint 115. The rain screen member 125 also has a water seal gasket 125b and a preferable overlapping leg 125c to minimize water entering the outer airloop space 121. In preferred embodiments, the sloping angle 126 is equal to or less than the horizontal roof slope angle 127 to prevent water from being trapped on the surface of the joint gap leg 125a. Exterior air entry into the outer airloop spaces 21 and 22 for pressure equalization is facilitated by mullion cavities being open at the roof eave, as explained below in the description FIGS. 5 and 8. A wiring hole 137 is shop drilled on the head frame member of panel 112 for connecting the mullion wire 134 to the electrical ports 128 of the solar energy unit in panel 112.

The primary difference between the embodiment shown in FIG. 3 and the embodiment shown in FIG. 2 is that the embodiment of FIG. 3 has back-up panels 129a, 129b in the solar energy units 111 and 112, with pressure equalized spaces 140a, 140b in front of each back-up panel 129a, 129b.

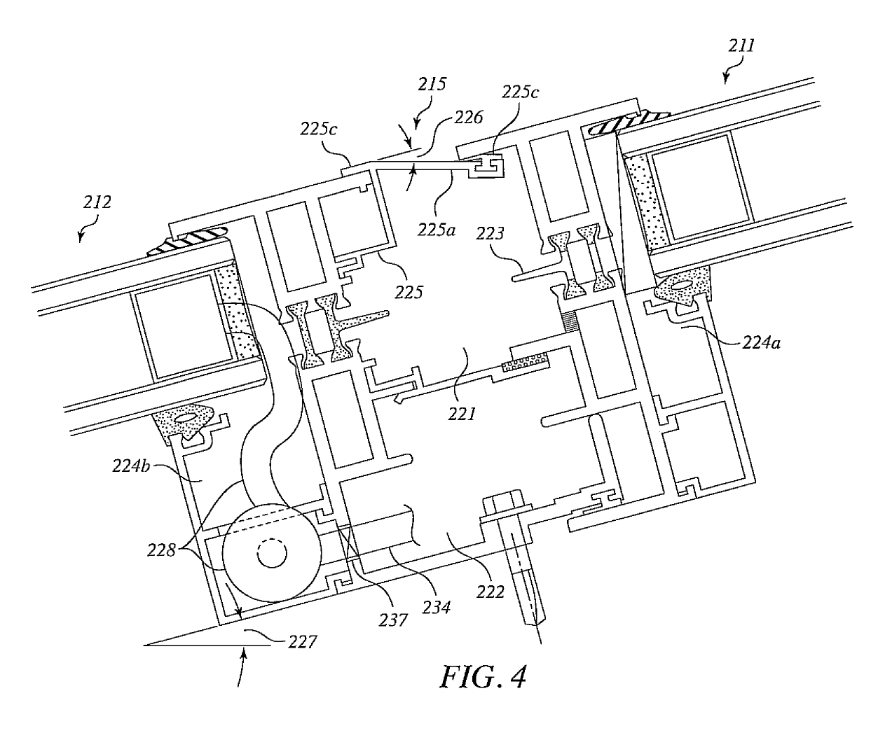

FIG. 4 shows a fragmental cross-section of another embodiment utilizing an insulated transparent or semi-transparent double glass solar energy roof system. Similar to FIG. 2 and FIG. 3, FIG. 4 shows a cross-section at a transverse joint 215 between a ridge panel 211 and an eave panel 212. Structural engagement of ridge panel 211 with eave panel 212 forms the outer airloop spaces 221 and 222. The inner airloop space 224a shown in the sill member of ridge panel 211 is connected to corresponding air spaces in the jamb members and head member of ridge panel 211 to form an inner airloop. Air holes 223 at the sill member of ridge panel 211 are provided to pressure equalize the inner airloop space 224a as explained in U.S. Pat. No. 7,134,247.

The inner airloop space 224b shown in the head member of eave panel 212 is connected to corresponding air spaces in the jamb members and sill members of eave panel 212 to form an inner airloop. Air holes at the sill member of eave panel 212 are provided to pressure equalize the inner airloop space 224b of the eave panel 212 with exterior air.

Like the embodiments shown in FIG. 2 and FIG. 3, a rain screen member 225 has a joint gap leg 225a with a sloping angle 226 with respect to the face of roof surface to allow water to flow downwardly over the panel joint 215. The rain screen member 225 also has a water seal gasket 225b and a preferable overlapping leg 225c to minimize water entering the outer airloop space 221. In preferred embodiments, the sloping angle 226 is equal to or less than the horizontal roof slope angle 227 to prevent water from being trapped on the surface of the joint gap leg 225a. Exterior air entry into the outer airloop spaces 21 and 22 for pressure equalization is facilitated by mullion cavities being open at the roof eave, as explained below in the description FIGS. 5 and 8. A wiring hole 237 is shop drilled on the head frame member of panel 212 for connecting the mullion wire 234 to the electrical ports 228 of the solar energy unit in panel 212.

The primary difference between the embodiment shown in FIG. 4 and the embodiment shown in FIG. 2 is the use of double glass solar energy units in panels 211, 212 in the embodiment shown in FIG. 4.

In the embodiments shown in FIGS. 2, 3, and 4, the panel engagement at joints 15, 115, 215 to form the outer airloop spaces 21, 121, 221, and 22, 122, 222, is identical. Therefore, different types of roof panels with integrated solar energy units can be mixed in forming a solar energy roof. Similarly, regular, non-solar energy panels can be combined with solar energy panels using the same type of panel engagement.

FIG. 5 is a symbolic fragmental cross-section taken along line 5-5 on FIG. 1 looking downwardly at the head frame members at the top of adjacent eave panels 12b, 12c (with the removal of ridge panels 11b, 11c for clarity), showing the engagement between each eave panel 12b, 12c and a supporting mullion 31. FIG. 5 also shows a preferred wiring path for making an electrical connection between the solar energy units in adjacent eave panels 12b, 12c, and shows modifications of an airloop mullion for water drainage.

The engagement of an airloop mullion 31 with the jamb frame members of panels 12b, 12c forms outer airloop spaces 21b, 22b, 21c, 22c. Air space 21c is openly connected with air space 21 (shown in FIG. 2) at the top of panel 12c, and air space 22c is openly connected with air space 22 (shown in FIG. 2) at the top of panel 12c. Similar open air space connections at the bottom of panel 12c and at the other jamb frame member of panel 12c complete the outer airloop that connects air spaces 21, 21c and 22, 22c. Outer airloop spaces are similarly formed around panel 12b by connection of air spaces 21b, 22b with air spaces around the perimeter frame of panel 12b.

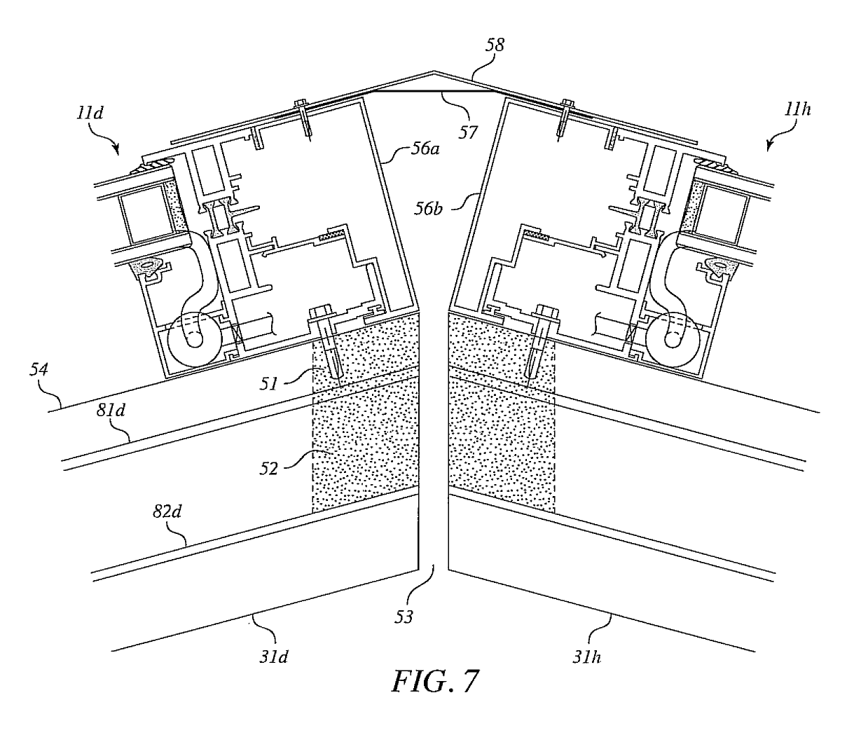

The air spaces 21b, 21c, 22b, 22c, 32 are capped and air sealed at the ridge 13 (shown in FIG. 7) and are completely open to the exterior air at the eave (shown in FIG. 8). Therefore, exterior air can easily enter into these air spaces from the eave to pressure equalize the outer airloop spaces 21, 21b, 21c, 22, 22b, 22c.

In the airloop mullion 31, two interior air chambers 32, 33 are created by two internal flanges 81, 82. In the airloop design principle, all sealing lines must be considered to be imperfect; therefore, an imperfect water seal line 85b, 85c is assumed. For a vertical curtain wall application as described in U.S. Pat. No. 7,134,247, due to air pressure equalization, there is no external force to push water to pass through the imperfect water seal line 85b, 85c; therefore, the second outer airloop space corresponding to air spaces 22, 22c, 22b is a dry airloop.

In the roof application of preferred embodiments of the present invention with a sloping roof, there is a gravitational component on water draining down along the imperfect water seal line 85b, 85c. Therefore, some water will seep through the water seal line 85b, 85c causing the outer airloop spaces 22b, 22c to become a wet space. Inevitably, the outside surface of the flange 81 must be utilized as a water drainage channel. Water can drain down the outside surface of the flange 81 and out at the roof eave since outer airloop spaces 22b, 22c are open at the roof eave (as shown in FIG. 8).

In preferred embodiments, a mullion wire 34 passes through the mullion 31 to make an electrical connection between solar energy units in adjacent panels 12b, 12c. The mullion wire 34 may be installed and connected as follows: (1) The mullion wire 34 with loose ends is shop-installed through holes 36a, 36b on flange 82 and holes 35a, 35b on flange 81. (2) After securing both the right and left panels 12b, 12c in the field, the loose ends of the mullion wire 34 are installed through the holes 37b, 37c on the head frame members of panels 12b, 12c for access to the electrical ports 39b (positive) and 39c (negative) on the solar energy units of panels 12b, 12c. (3) Mullion wire connectors 38b (negative), 38c (positive) are field-installed on the mullion wire 34. (4) Connector 38b (negative) is connected to the positive port 39b on panel 12b, and connector 38c (positive) is connected to the negative port 39c on panel 12c to complete the electrical connection in a series configuration.

At the end of a row of panels with integrated solar energy units, a mullion wire connected to the solar energy unit in the end panel may be passed through the mullion chamber corresponding to chamber 33 shown in FIG. 5 for connection to an above or below panel, or to the wiring system leading to a building power distribution center.

In preferred embodiments of the solar energy roof system of the present invention, the air chamber 32 is pressure-equalized as explained as follows. The holes 35a, 35b penetrated by the mullion wire 34 are shop-sealed to prevent draining water from seeping through the holes 35a, 35b around the wire 34. In the airloop design principle, all seals must be considered to be imperfect; therefore, the air chamber 32 must also be pressure-equalized to eliminate external water infiltration force caused by positive wind load. The pressure equalization of air chamber 32 is achieved by capping and sealing at the ridge (shown in FIG. 7) and opening to exterior air at the eave (shown in FIG. 8).

Upon the pressure equalization of air chamber 32, the remaining secondary water infiltration force is the gravitational component of draining water; however, this secondary force will not cause water infiltration through the imperfect tiny shim seal around the wire 34 due to the surface tension of the water. A further preferred feature is to provide a slight sloping surface 91 on the flange 81 over the area of the holes 35a, 35b to further discourage water from running to the locations of the holes 35a, 35b. In the above arrangements, the air chamber 32 becomes a pressure-equalized dry air space and only the air chamber 33 is in the interior air zone. The air chamber 33 is readily accessible for any additional field wiring operations in the up or down direction. Upon completion of the installation, a snap-on mullion cover 92 may be installed to hide wires in the air chamber 33.

If further reduction of the amount of water draining down along the surface of flange 81 is desirable, then a preferred feature is to cap the longitudinal panel joint along the million 31 with the following components: (1) spaced apart clips 93 secured to the airloop mullion 31; (2) a continuous pressure bar 94 fastened to the clips 93; (3) a continuous snap-on cover 95 engaged with the pressure bar 94. A further preferred feature of the cover 95 is to provide a sloping surface 96 toward the center of the cover 95 to allow direct water drainage on top of the cover 95.

FIG. 6 is a fragmental isometric view from the interior side looking upwardly towards the bottom of the head frame members 41b, 41c of the panels 12b, 12c on both sides of the mullion 31 to illustrate more clearly the wiring path and the enclosure to hide the wires from interior view. FIG. 6 provides a three dimensional sense of the combination of the view shown in FIG. 5 and any one of the embodiments shown in FIG. 2, 3, or 4. The field installation steps for making an electrical connection between the solar energy units of adjacent panels 12b, 12c are: (1) The mullion wire 34 is guided through the shop-drilled holes 37b, 37c into the interior side of the panels 12b, 12c. (2) The mullion wire connectors 38b, 38c are field-assembled to match the positive port 39b on the right panel 12b and the negative port 39c on the left panel 12c, respectively. (3) The wire connectors 38b, 38c are connected to the ports 39b, 39c respectively. (4) The head glazing beads 42b, 42c are engaged into position to hide all the wires in the panels 12b, 12c from interior view. (5) The mullion cover 92 is snapped onto the mullion 31 to hide wires inside the mullion 31 from interior view. The head glazing beads 42b, 42c preferably have notches at the locations of wires and wire connectors to allow wires to pass through and/or to accommodate space taken up by wire connectors.

FIG. 7 is a fragmental cross-section taken along line 7-7 on FIG. 1 showing preferred design details at a typical ridge of the present invention. In this embodiment, panels 11d, 11h have integrated, insulated transparent or semi-transparent double glass solar energy units. Mullions 31d, 31h have the same design as the mullion 31 shown in FIGS. 5 and 6.

An air block 51 between the interior panel line 54 and the internal mullion flange 81d is shop-installed to prevent the exterior air in the outer airloop space (corresponding to air space 22b or 22c shown in FIG. 5) from entering the interior air zone 53. Since the air chamber corresponding to air chamber 32 shown in FIG. 5 is pressure-equalized with exterior air, an air block 52 to block the air chamber at the ridge location is also provided to prevent the exterior air inside the air chamber from entering the interior air zone 53. A continuous ridge cap 56a is engaged and sealed to the ridge panel 11d and also sealed to the air block 51. The continuous ridge cap 56a is similarly engaged and sealed to the ridge panels 11a, 11b, 11c (shown in FIG. 1) in the same row, and sealed to corresponding air blocks on other mullions supporting the ridge panels 11a, 11b, 11c, 11d.

Ridge panel 11h and mullion 31h have the same configurations as ridge panel 11d and mullion 31d. Continuous ridge cap 56b is sealed to ridge panels 11e, 11f, 11g, 11h and air blocks on mullions in the same manner that continuous ridge cap 56a is sealed to ridge panels 11a, 11b, 11c, 11d and air blocks on mullions.

A waterproofing membrane 57 is installed to bridge over the top gap between the ridge caps 56a, 56b. A ridge flashing 58 is fastened to the ridge caps 56a, 56b through the membrane 57 to complete the ridge structure. The same concept with slight modification can be readily contemplated for a single sloping solar energy roof.

FIG. 8 is a fragmental cross-section taken along line 8-8 on FIG. 1 showing preferred design details at a typical eave of the present invention. Since the air chamber 33 (shown in FIG. 5) is utilized for housing electrical wires, it can also be referred to as a wiring chamber 33. The wiring chamber 33 is notched out near the location of the eave wall 61 such that the bottom surface of the flange 82 (also shown on FIG. 5) is exposed. A continuous flashing 62 with extended waterproof membrane 63 is installed on the top of the eave wall 61. An air closure flashing 64 is installed in each mullion bay. To prevent exterior air from entering the interior air zone at the eave location, an air seal 65 is applied between flashings 62 and 64 and another air seal 69 is applied between flashing 64 and the sill frame member 66 of panel 12b. The outer airloop space 22b (shown in FIG. 5) between the interior wall line 154 and the flange 81 and the air chamber 32 (shown in FIG. 5) are completely open to the exterior air at the eave end of the mullion 31 allowing effective pressure equalization at all locations mentioned for the previously explained figures.

Another preferred feature is to provide a continuous wind shield member 67 secured to a roof starter member 68. The wind shield member 67 in front of the above-mentioned open mullion end air spaces will prevent excessive wind-driven rain water from entering the mullion cavities.

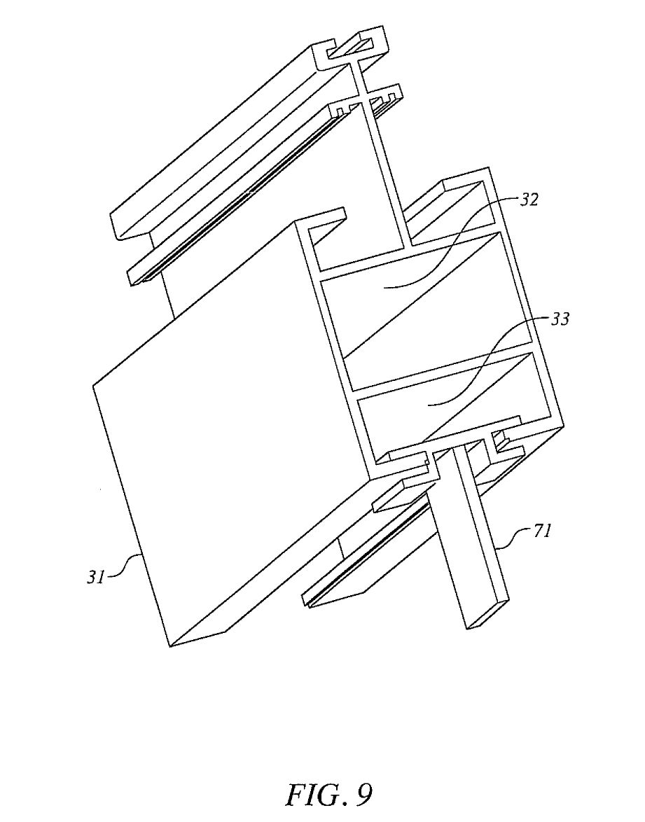

FIG. 9 is a fragmental isometric view of a mullion 31 with a structurally engaged mullion connection clip 71 for structural connection to the roof supporting member. This mullion connection technology is disclosed in U.S. Patent Application Publication Number 2013/0186031, which is incorporated by reference. The mullion connection clip 71 is engaged with the mullion 31 via a pair of matching male and female joints.

The matching male and female joints permit free relative sliding between the connection clip 71 and the mullion 31. This free relative sliding permits adjustment of the connection clip to absorb any construction tolerance while maintaining connection strength. In addition, the engagement between the clip 71 and the mullion 31 can have stress-free relative sliding in case of thermal movements, while maintaining strong resistance against wind uplifting load reaction. Further, no fastener penetrating into the wiring chamber 33 is required; therefore, an uninterrupted wiring chamber as required by building codes is formed. To account for the small gravitational component of the dead load of the sloping roof, a dead load clip may be fastened to the mullion 31 with penetration into the air chamber 32 at only one connection location on each mullion.

As one of ordinary skill in the art would recognize, many variations exist for the engagement between the mullion connection clip and mullion, such as those disclosed in U.S. Patent Application Publication Number 2013/0186031. One of ordinary skill in the art also would recognize many possibilities for connecting the mullion connection clip 71 to a roof supporting structure.

Solar energy units may be replaced if damaged or dysfunctional, to upgrade to new solar energy technology, or for any other reason replacement is desired. In preferred embodiments, roof panels are designed for easy replacement of an integrated solar energy unit. In preferred embodiments, each roof panel has a panel perimeter frame with a head frame member, two jamb frame members, and a sill frame member. A solar energy unit is structurally secured inside the panel frame with a demountable glazing bead on each frame member. The glazing beads on the sill frame member and two jamb frame members preferably are installed in the shop, prior to panel erection. The head frame glazing bead is installed during panel erection, as described above. In the event that replacement of the solar energy unit is desired, the solar energy unit may easily be removed by removing the glazing beads and disconnecting the solar energy unit's wire connectors. A new solar energy unit may then be inserted into the panel frame, new wire connections are made, and the new solar energy unit secured by reinstalling the glazing beads.

The preferred embodiments shown in the figures are designed to permit replacement of a solar energy unit from the building interior. As one of ordinary skill in the art would recognize, the roof panel frame members and glazing beads also may be designed to permit replacement of a solar energy unit from the building exterior.

Nothing in the above description is meant to limit the present invention to any specific materials, geometry, or orientation of elements. Many modifications are contemplated within the scope of the present invention and will be apparent to those skilled in the art. The embodiments described herein were presented by way of example only and should not be used to limit the scope of the invention.

1. An integrated solar energy roof system comprising:
a first airloop roof panel comprising a first solar energy unit secured in a first perimeter frame,
a second airloop roof panel comprising a second solar energy unit secured in a second perimeter frame,
a mullion engaged with said first perimeter frame and engaged with said second perimeter frame,
wherein the engagement of said mullion with said first perimeter frame forms an air space between said mullion and said first perimeter frame,
wherein said air space is pressure equalized with an air chamber in said mullion, said air chamber open to exterior air, and
a mullion wire passing through said first perimeter frame, said mullion, and said second perimeter frame to provide an electrical connection between said first solar energy unit and said second solar energy unit.

2. The integrated solar energy roof system of claim 1, wherein said first solar energy unit is an uninsulated, single glass solar energy unit.

3. The integrated solar energy roof system of claim 1, wherein said first solar energy unit is an insulated, double glass solar energy unit.

4. The integrated solar energy roof system of claim 1, further comprising a structural back-up panel secured in said first perimeter frame.

5. The integrated solar energy roof system of claim 1, wherein said mullion comprises a second air chamber sealed from exterior air, and said mullion wire passes through said second air chamber.

6. The integrated solar energy roof system of claim 1, wherein said first solar energy unit can be removed from said first perimeter frame from a building interior.

7. An integrated solar energy roof system comprising:
a first airloop roof panel comprising a first solar energy unit secured in a first perimeter frame,
a second airloop roof panel comprising a second solar energy unit secured in a second perimeter frame, wherein said first perimeter frame and said second perimeter frame engage to form a first air space between said first perimeter frame and said second perimeter frame,
a mullion engaged with said first perimeter frame and engaged with said second perimeter frame,
wherein the engagement of said mullion with said first perimeter frame forms a second air space between said mullion and said first perimeter frame,
wherein said first air space is openly connected with said second air space, and
wherein said second air space is pressure equalized with an air chamber in said mullion, said air chamber open to exterior air.

8. The integrated solar energy roof system of claim 7, wherein said first solar energy unit is an uninsulated, single glass solar energy unit.

9. The integrated solar energy roof system of claim 7, wherein said first solar energy unit is an insulated, double glass solar energy unit.

10. The integrated solar energy roof system of claim 7, further comprising a structural back-up panel secured in said first perimeter frame.

11. The integrated solar energy roof system of claim 7, wherein said mullion comprises a second air chamber sealed from exterior air, and said mullion wire passes through said second air chamber.

12. The integrated solar energy roof system of claim 7, wherein said first solar energy unit can be removed from said first perimeter frame from a building interior.
